(19) United States
(12) Patent Application Publication
(10) Pub. No.: US 2016/0324063 A1
(43) Pub. Date: Nov. 10, 2016

(54) TRACTOR CART SYSTEM

(71) Applicant: Turnberry Innovations, LLC, Marietta, GA (US)

(72) Inventor: Peter Shaw, Hilton Head, SC (US)

(73) Assignee: Turnberry Innovations, LLC, Marietta, GA (US)

(21) Appl. No.: 15/051,427

(22) Filed: Feb. 23, 2016

Related U.S. Application Data
(60) Provisional application No. 62/158,720, filed on May 8, 2015.

(51) Int. Cl. A01B 59/00; B60R 9/06

(52) U.S. Cl. CPC A01B 59/00; B60R 9/06

(57) ABSTRACT

A tractor cart system for attaching to a vehicle with a three point hitch is disclosed. The tractor cart system has a body having a bed, a three point hitch positioned substantially on the front of the body for engaging a three point hitch of the vehicle, and a rear connector positioned substantially on the rear of the body configured to engage one of a plurality of tractor attachments.

### CONTINUITY

This application claims priority to and the benefit of U.S. Provisional Patent Application Ser. No. 62/158,720, entitled Field Caddy, filed on May 8, 2015, which is incorporated herein in its entirety.

### FIELD OF THE INVENTION

The present invention relates generally to a tractor cart system and, more specifically, the present invention relates to a tractor cart system for use with a tractor and tractor implement.

### BACKGROUND OF THE INVENTION

On a farm or on a large piece of property, tractors are generally used to mow, till, or otherwise work the land. In these instances, trucks, trailers, 4-wheelers, and other vehicles are used to haul things and carry materials and other tools to a work site.

It remains desirable in the art to provide a tractor cart system that addresses the limitations associated with known systems, including but not limited to those limitations discussed above.

### SUMMARY OF THE INVENTION

In accordance with the purposes of this invention, as embodied and broadly described herein, this invention, in one aspect, relates to a tractor cart system for attaching to a vehicle with a three point hitch. In one aspect, the system comprises a body having a bed, a three point hitch positioned substantially on the front of the body for engaging a three point hitch of the vehicle, and a rear connector positioned substantially on the rear of the body configured to engage one of a plurality of tractor attachments.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of one aspect of a tractor cart system;

FIG. 2 is a lower perspective view of the tractor cart system of FIG. 1, showing the front end of the body;

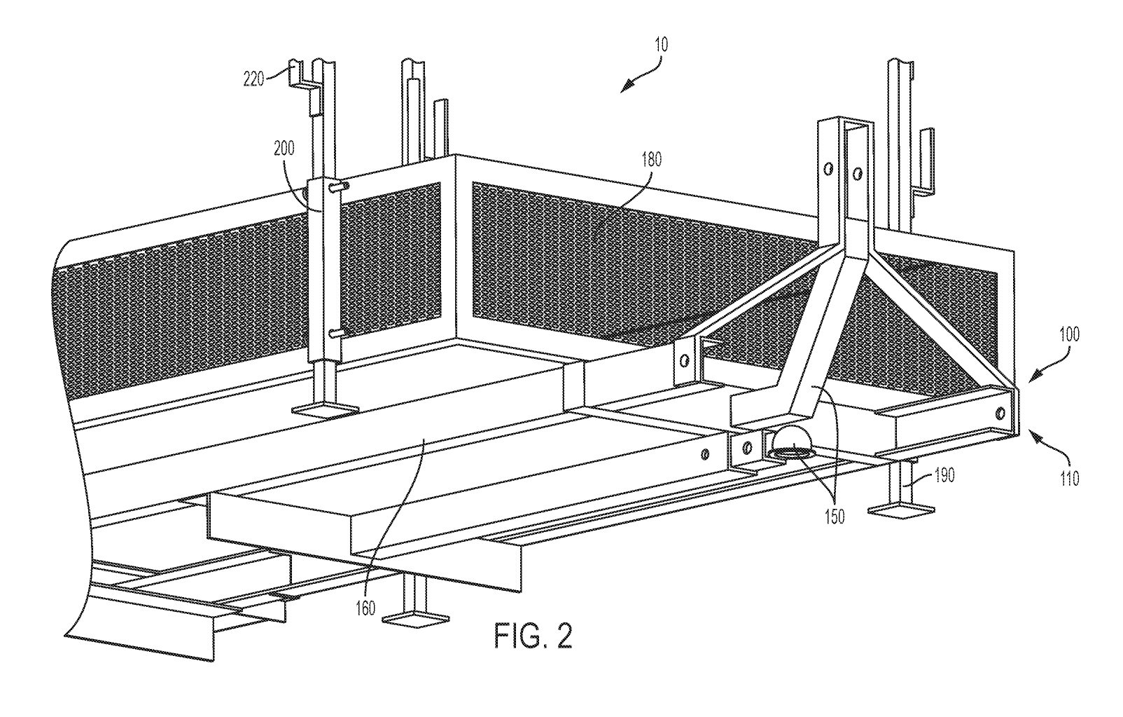

FIG. 3 is a perspective view of the front end of the tractor cart system of FIG. 1;

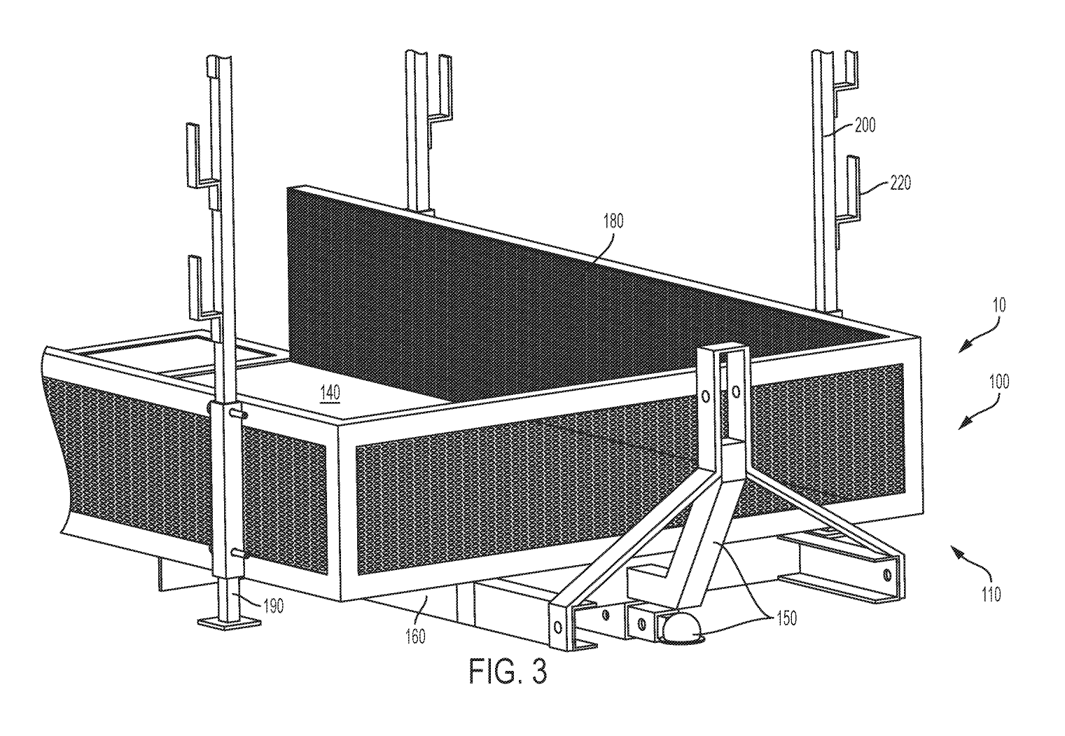

FIG. 4 is a bottom perspective view of the tractor cart system of FIG. 1:

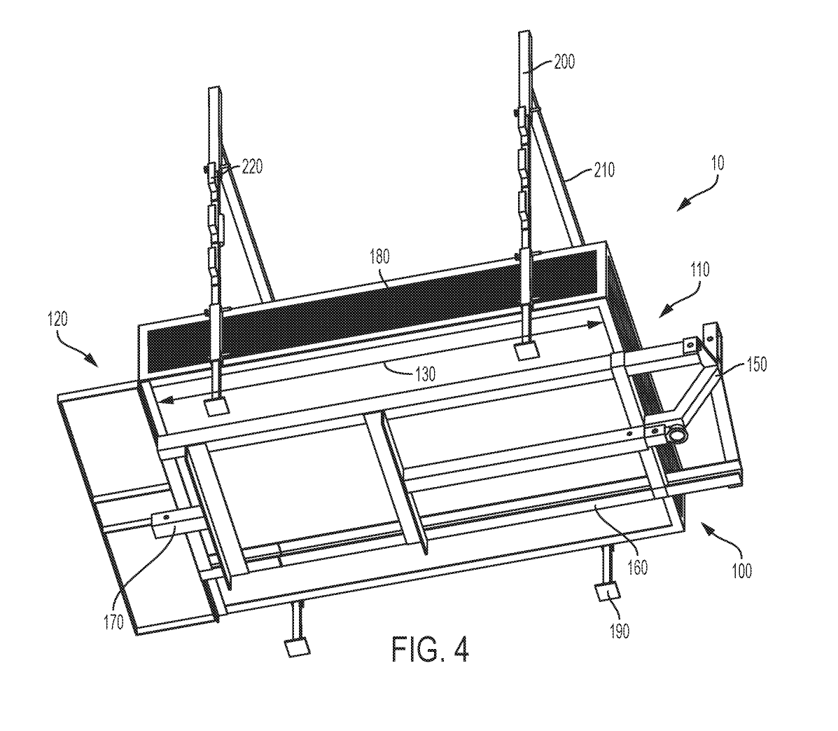

FIG. 5 is a partial perspective view of the tractor cart system of FIG. 1, showing the tailgate in the open position;

FIG. 6 is a bottom front perspective view of one aspect of a tractor cart system having a central longitudinal rail;

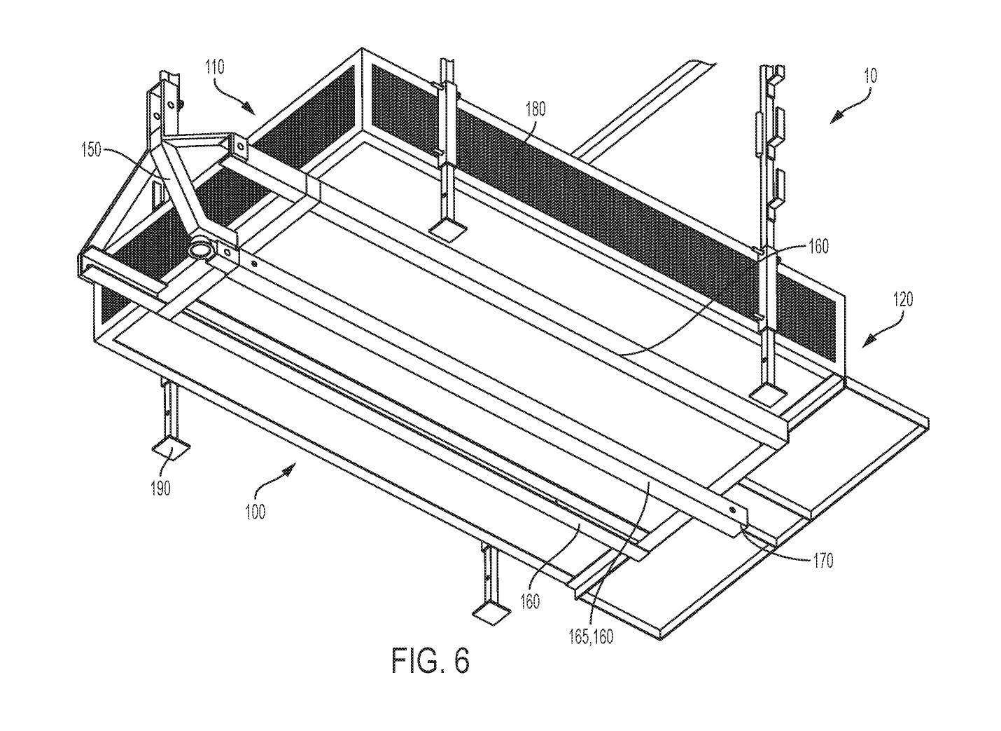

FIG. 7 is a rear perspective view of the tractor cart system of FIG. 6;

FIG. 8 is a bottom rear perspective view of the tractor cart system of FIG. 6, showing the tail gate in the open position;

FIG. 9 is a bottom rear perspective view of the tractor cart system of FIG. 6; and

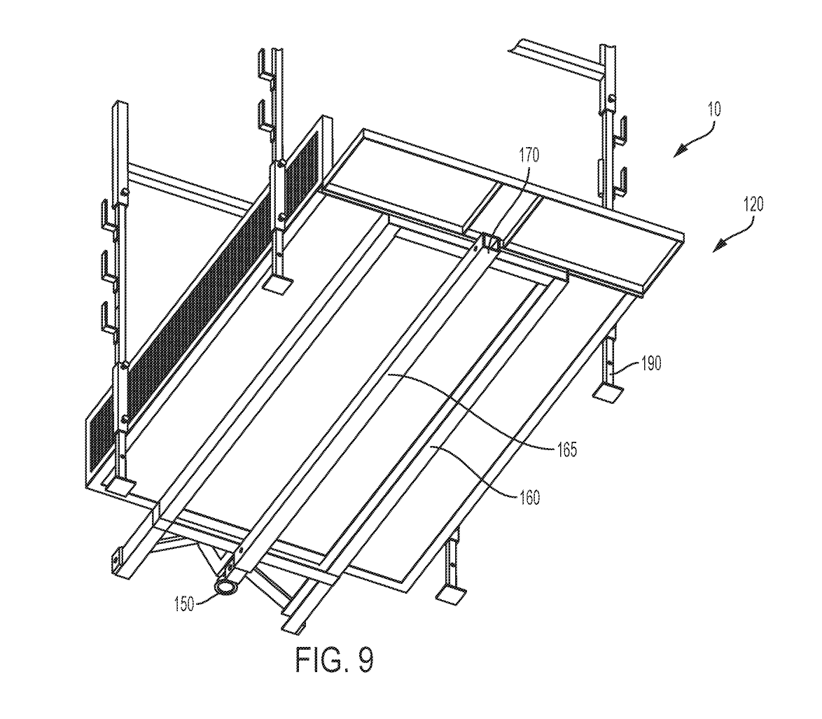

FIG. 10 is a perspective view of a plurality of exemplified tractor attachments for use with the tractor cart system of FIG. 6.

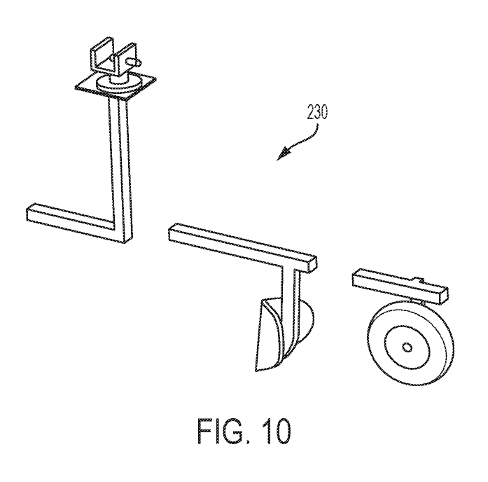

### DESCRIPTION OF THE PREFERRED EMBODIMENTS

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof

As used herein, the singular forms “a,” “an” and “the” include plural referents unless the context clearly dictates otherwise. Thus, for example, reference to a “rail” includes aspects having two or more rails unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

The term “substantially,” as used herein, may be applied to modify any quantitative representation which could permissibly vary without resulting in a change in the basic function to which it is related.

Additionally, descriptive terms, such as “first” or “second” do not necessarily connote plural referents. Alternatively, these terms are merely used to differentiate one object from another or to simply describe a single object. They are not necessarily to be considered in numerical order. For example, a “first object” could just as easily be named “object A” or the like.

Reference will now be made in detail to various embodiments of the present invention, examples of which are illustrated in the accompanying drawings. Wherever possible, the same reference numbers are used throughout the drawings to refer to the same or like parts.

In one aspect, described herein is a tractor cart system 10 comprising a body 100 having a bed 140, a three point hitch 150 positioned substantially on the front 110 of the body 100 for engaging a complementary three point hitch of a vehicle, and a rear connector 170 positioned substantially on the rear 120 of the body 100 configured to engage one of a plurality of tractor attachments 230. By vehicle, it is intended to mean tractor or other wheeled vehicle with a three point hitch.

In an exemplified aspect, the body comprises at least one structural rail 160 substantially spanning the longitudinal length 130 and capable of being supported solely by the three point hitch 150. As such, the entire cart system may be lifted by raising the three point hitch on the vehicle, limited only by the weight of the cart system and counter weight of the vehicle. For example, if the cart system is too heavy, it is possible to lift the front wheels of the vehicle off of the ground.

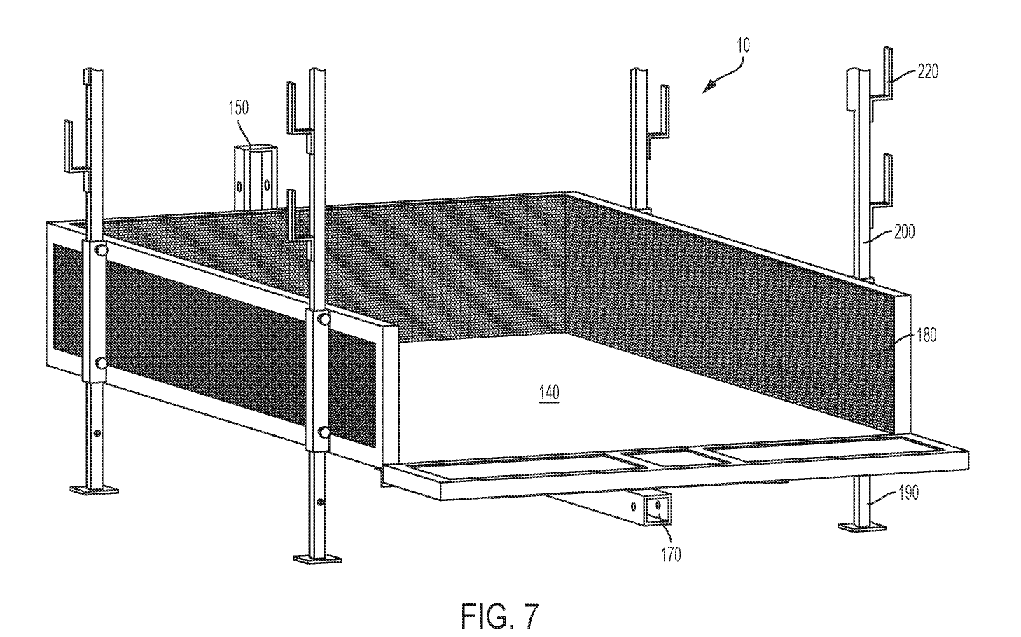

It is contemplated that there can be a plurality of structural rails 160 substantially spanning the longitudinal length 130 of the body 100. In one aspect, there can be a central rail 165, substantially spanning the longitudinal length substantially bisecting the body, connecting the three point hitch to the rear connector 170, as shown in FIG. 7.

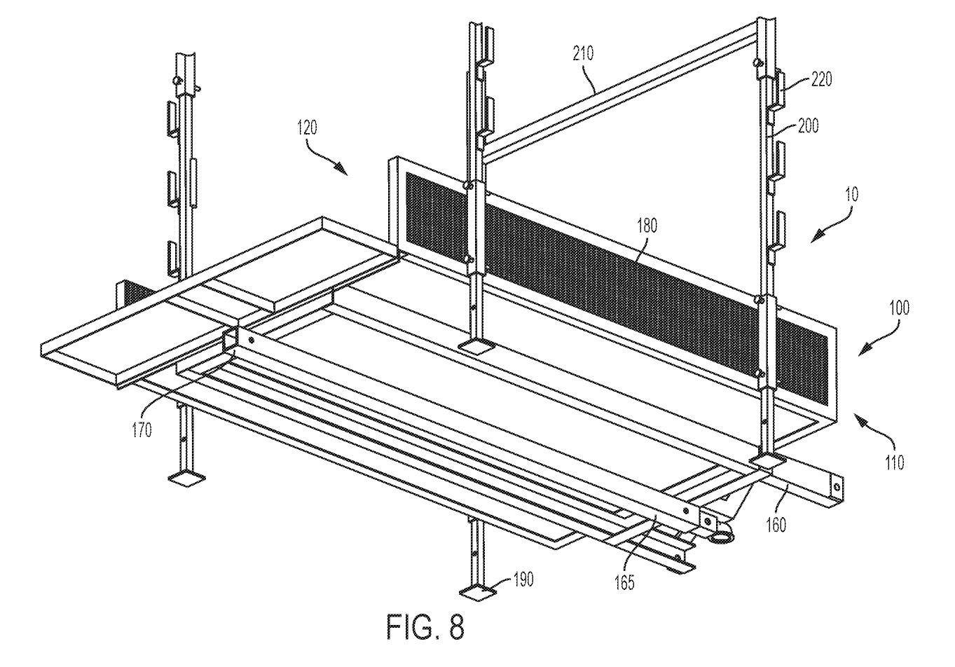

The rear connector 170 can be, for example, a tow bar, as shown in FIG. 8, but other connection mechanisms are contemplated. In another aspect, the tractor attachment 230 can be, for example, and not meant to be limiting, a box blade, scraper, plugger, aerator, tiller, rake, or wheel.

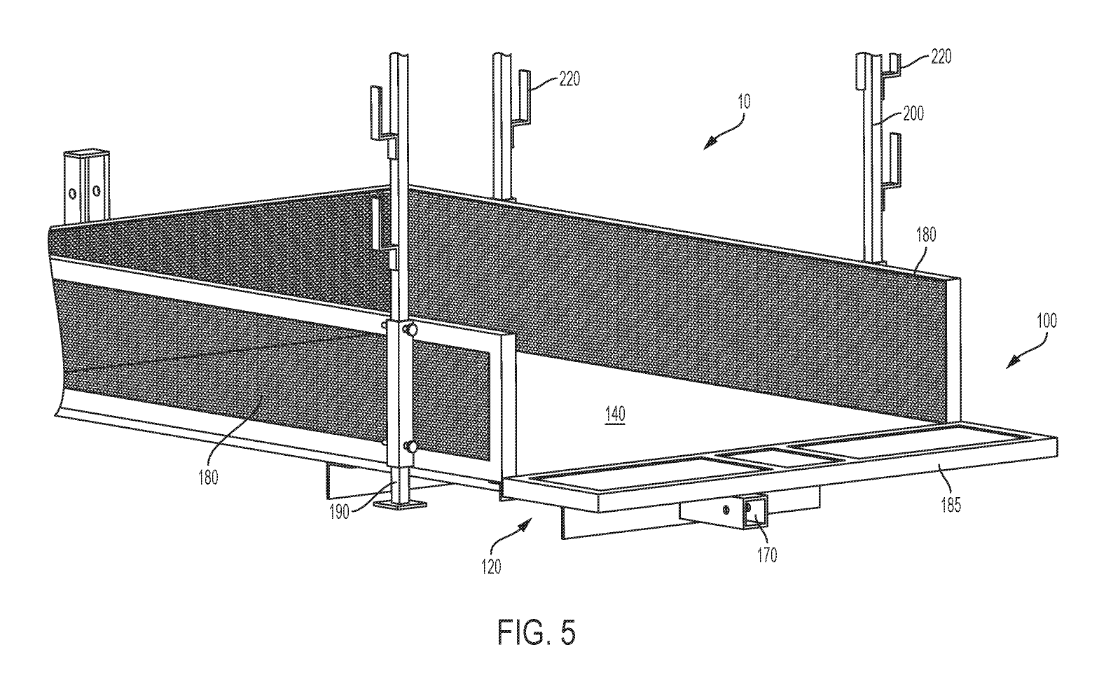

In one exemplified aspect, as shown in FIG. 5, the body 100 can have three side walls 180 and a rear gate 185, or any combination thereof. The gate can be akin to a tail gate on a pick-up truck and can be hingedly connected to a rear portion of the body.

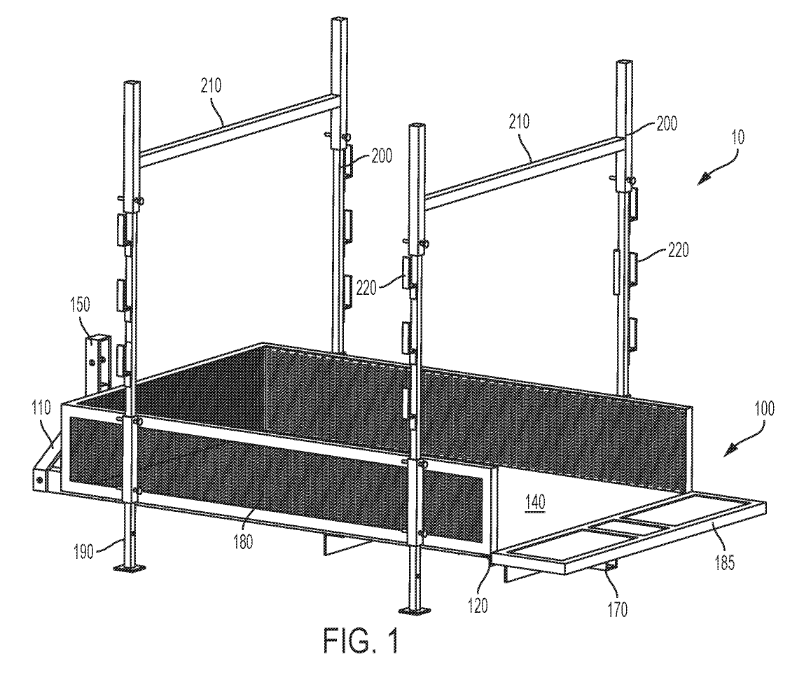

In still another aspect, the system also comprises a plurality of downwardly extending legs 190 extending downwardly from the body 100 configured to substantially level the body when the system is not moving, as shown in FIG. 1 and FIG. 8. The legs, for example, can comprise telescoping legs. This permits the body 100 to stand independently of the vehicle or while it is connected thereto. Additionally, the system can also have a plurality of vertical rails 200 extending upwardly from the body. The vertical rails can, for example, comprise a telescoping feature with a sleeve and post, where the post defines a plurality of adjustment bores configured to accept locking pins. The rails can be two pairs of vertical rails 200, each pair connected by a horizontal top rail, as shown in FIG. 1. The top rail(s) can comprise an “H” shape and be placed on top of opposing vertical rails. This configuration permits wood or other long objects to be carried thereon the horizontal top rails 210. In still another aspect, at least one of the rails comprises a hook 220 attached thereto. The hook can be hook shaped, an L bracket, a C bracket, and the like.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein.

What is claimed is:

1. A tractor cart system comprising:
a body having a bed, a front, a rear, a longitudinal length running from substantially the front to the rear, a first side and a second side;
a three point hitch positioned substantially on the front of the body for engaging a three point hitch of a vehicle; and
a rear connector positioned substantially on the rear of the body configured to engage one of a plurality of tractor attachments;
wherein the body comprises at least one structural rail substantially spanning the longitudinal length and capable of being supported solely by the three point hitch.

2. The system of claim 1, comprising a plurality of structural rails spanning the longitudinal length.

3. The system of claim 1, wherein at least one of the structural rails is a central rail, substantially spanning the longitudinal length substantially bisecting the body, connecting the three point hitch to the rear connector.

4. The system of claim 1, wherein the tractor attachment is a box blade, scraper, plugger, aerator, tiller, rake, or wheel.

5. The system of claim 1, wherein the rear connector is a tow bar.

6. The system of claim 1, wherein the body further comprises three side walls and a rear gate.

7. The system of claim 1, further comprising a plurality of telescoping legs extending downwardly from the body configured to substantially level the body when the system is not moving.

8. The system of claim 1 further comprising a plurality of vertical rails extending upwardly from the body.

9. The system of claim 8, wherein the plurality of vertical rails comprises two pairs of vertical rails, each pair connected by a horizontal top rail.

10. The system of claim 8, wherein at least one of the rails comprises a hook attached thereto.
